(19) United States
(12) Patent Application Publication
(10) Pub. No.: US 2014/0062824 A1
(43) Pub. Date: Mar. 6, 2014

(54) CIRCULAR POLARIZATION ANTENNA AND DIRECTIONAL ANTENNA ARRAY HAVING THE SAME

(71) Applicant: HON HAI PRECISION INDUSTRY CO., LTD., New Taipei (TW)

(72) Inventors: TAIICHI YAMAGUCHI, Yokohama (JP); CHANG-CHING LIN, New Taipei (TW); JOHN CHOW, Saratoga, CA (US); YUN-CHENG HOU, New Taipei (TW); SHENG-CHE CHANG, New Taipei (TW); CHUN-CHIEH TSENG, New Taipei (TW)

(73) Assignee: HON HAI PRECISION INDUSTRY CO., LTD., New Taipei (TW)

(21) Appl. No.: 14/016,447

(22) Filed: Sep. 3, 2013

(30) Foreign Application Priority Data
Sep. 3, 2012 (TW) 101132086

(51) Int. Cl. H01Q 9/04

(52) U.S. Cl. CPC H01Q 9/0428; H01Q 9/045
USPC 343/835; 343/834; 343/848

(57) ABSTRACT

An antenna array (1000) includes a horizontal ground layer (40) having a central hole (401), a radiation layer parallel to the ground layer, and a coaxial cable (5) assembled to the ground layer. The cable includes a central conductor (51), an insulated layer (53) coated on the central conductor, and a grounding coat (52) coated on the insulated layer. The central conductor extends through the central hole from a bottom side of the ground layer and keeping insulated from the ground layer. The radiation layer includes a number of radiation units (30) which are coplanar with each other and parallel to the ground layer. Each radiation unit has a nail (301) extending downwardly towards the ground layer. The nail resonates with the central conductor when the antenna array is transmitting or receiving radio frequency signals.

### BACKGROUND OF THE INVENTION

1. Field of the Invention

The present invention concerns a directional antenna array with circular polarization antenna, particularly for a directional antenna array with circular polarization antenna which is used in application of millimeter wave communication.

2. Description of Related Art

With increasing use of mobile media devices, a high bandwidth antenna for sending and receiving large amounts of voice, video, imaging, and data information is needed. The antenna based on 60 GHz bandwidth could be developed for using in such application. As disclosed by U.S. Pat. No. 7,595,766 issued to Rofougaran on Sep. 29, 2009, an integrated circuit antenna has an antenna element, a ground plane, and a transmission line. The antenna element may be vertically positioned with respect to the ground plane. The ground plane may be circular shaped, elliptical shaped, rectangular shaped, or any other shape to provide an effective ground for the antenna element. The ground plane may include an opening to enable the transmission line to be coupled to the antenna element. The antenna structure may include a plurality of discrete antenna elements, e.g., infinitesimal antennas having a length less or equal to 1/50 wavelength or small antennas having a length less or equal to 1/10 wavelength, which functions similarly to a continuous horizontal dipole antenna. U.S. Pat. No. 7,821,460 issued to Schillmeier et al. on Oct. 26, 2010 disclose a patch antenna wherein a feed line extends through a ground surface for electrically connecting with an effective surface.

U.S. Pat. No. 7,830,312, issued to Choudhury et al. on Nov. 5, 2010, discloses a directional antenna array assembly which is used around 60 GHz band wireless communication. The antenna array assembly includes a plurality of mm-wave planar antennas arrayed on a first substrate, a plurality of vias, e.g., using shielded stripline or microstrip type transmission structures, extending through a second substrate, and a plurality of end-fire antennas positioned on a third substrate. The conductive vias carry radio frequency (RF) signals from the first substrate to the third substrate, or vice versa. The planar antennas and the end-fire antenna are connected through the second substrate vias to an integrated circuit. The antenna array assembly may be configured to provide complete azimuth beam coverage in a circular design across 360 degrees, or provide azimuth and elevation beam coverage from a plurality of azimuth beams and a plurality of elevation beams.

U.S. Pat. No. 8,482,463, issued to Babakhani et al. on Jul. 9, 2013, discloses a near-field resonant coupled antenna structure to “suck” out the power from an on-chip component and couple it to a printed circuit board (PCB) based off-chip antenna. Two loops, each including an inductor with a capacitor, or any suitable resonant structures within the near field of each other can be used.

It is desired to design a simple directional antenna array for transmitting and/or receiving radio frequency signals by resonating between two antenna elements.

### SUMMARY OF THE INVENTION

Accordingly, an object of the present invention is to provide a low attenuation circular polarization antenna and a directional antenna array having the same.

In order to achieve the object set forth, a circular polarization antenna in accordance with the present invention includes a horizontal ground layer having a central hole therein, a radiation layer parallel to ground layer, and a coaxial cable assembled to the ground layer. The coaxial cable has a central conductor, an insulated layer coated on the central conductor, and a grounding coat coated around the insulated layer for shielding the central conductor. The central conductor upwardly extends through the central hole, towards but not contacting with the radiation layer, and electrically insulates from the ground layer. The grounding coat electrically connects with the grounding layer for fixing the coaxial cable and grounding layer together. The circular polarization antenna further includes a feed-in portion vertically extending from the radiation layer to the ground layer.

A directional antenna array is formed by arraying a plurality of said circular polarization antennas which have a common ground layer. Furthermore, the radiation layer of the directional antenna array is composed of a plurality of radiation units which are coplanar with each other and parallel to the ground layer. The directional antenna array has a plurality of nails each vertically extending from said radiation unit to the ground layer. The nails are configured for resonating with the central conductor for transmitting or receiving radio frequency signals.

### BRIEF DESCRIPTION OF THE DRAWINGS

FIG. 1 is an exploded view showing a circular polarization antenna in accordance with the present invention;

FIG. 2 is an exemplary line graph of axial ratio (in decibels) versus frequency 59 GHz to 61 GHz band for the circular polarization antenna as shown in FIG. 1;

FIG. 3 is a peak gain pattern of the circular polarization antenna as shown in FIG. 1;

FIG. 4 is a radiation pattern of the circular polarization antenna as shown in FIG. 1;

FIG. 5 is a Smith chart of the circular polarization antenna as shown in FIG. 1;

FIG. 6 is the return loss versus the operating frequency of the circular polarization antenna as shown in FIG. 1;

FIG. 7 is an exploded view showing a directional antenna array in accordance with the first embodiment of the present invention;

FIG. 8 is an exploded view similar to FIG. 7, taken from another aspect;

FIG. 9 is a bottom view of the antenna array as shown in FIG. 8;

FIG. 10 is a cross-sectional illustration of the antenna array of FIG. 9.

FIG. 11 is an exemplary line graph of axial ratio (in decibels) versus frequency 59 GHz to 61 GHz band for the antenna array as shown in FIG. 7;

FIG. 12 is a peak gain pattern of the circular polarization antenna as shown in FIG. 7;

FIG. 13 is an exploded view showing a directional antenna array in accordance with the second embodiment of the present invention;

FIG. 14 is an exploded view showing a directional antenna array in accordance with the third embodiment of the present invention;

FIG. 15 is a graph of axial ratio lines (in decibels) versus frequency 57 GHz to 63 GHz band for the antenna arrays as shown in FIG. 13 and FIG. 14;

FIG. 16 is a peak gain pattern of the antenna arrays as shown in FIG. 13 and FIG. 14;

FIG. 17 is an exploded view showing a directional antenna array in accordance with the fourth embodiment of the present invention;

FIG. 18 is an axial ratio line (in decibels) versus frequency 57 GHz to 63 GHz band for the antenna arrays as shown in FIG. 17;

FIG. 19 is a peak gain pattern among the frequency 57 GHz to 63 GHz band of the antenna array as shown in FIG. 17;

FIG. 20 is an exploded view showing a directional antenna array in accordance with the fifth embodiment of the present invention;

FIG. 21 is an axial ratio line (in decibels) versus frequency 57 GHz to 63 GHz band for the antenna arrays as shown in FIG. 20;

FIG. 22 is a peak gain pattern of the antenna array as shown in FIG. 20;

FIG. 23 is an exploded view showing a directional antenna array in accordance with the sixth embodiment of the present invention;

FIG. 24 is an exploded view showing a directional antenna array in accordance with the seventh embodiment of the present invention;

FIG. 25 is a lateral view of the antenna array as shown in FIG. 23 and taken away the side wall 42, waveguide 41 as shown in FIG. 8;

FIG. 26 is a graph of axial ratio lines (in decibels) of the antenna arrays as shown in FIG. 23 and FIG. 24; and

FIG. 27 is a peak gain pattern of the antenna arrays as shown in FIG. 13 and FIG. 14.

### DETAILED DESCRIPTION OF THE PREFERRED EMBODIMENT

Reference will now be made in detail to the preferred embodiment of the present invention.

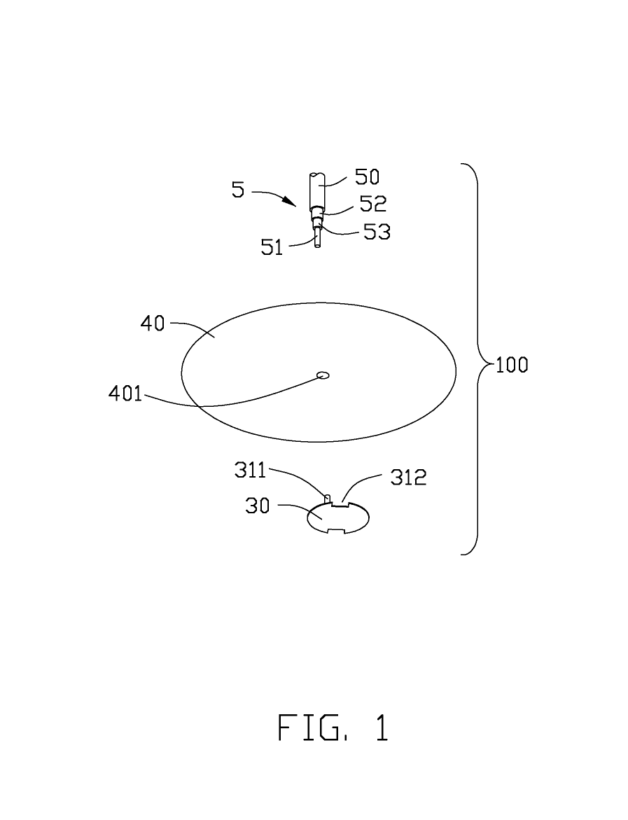

Referring to FIG. 1, a circular polarization antenna 100 in accordance with the present invention includes a horizontal ground layer 40 having a central hole 401 therein, a circular sheet shaped radiation layer 30 parallel to the ground layer 40, and a coaxial cable 5 assembled to the ground layer 40. The coaxial cable 5 has a central conductor 51, an insulated layer 53 coated on the central conductor 51, a grounding coat 52 coated around the insulated layer 53 for shielding said central conductor 51, and preferably having a outer insulative coat 50 overlapped on the grounding coat 52. The central conductor 51 upwardly extends through the central hole 401, vertically extending from the ground layer 40 towards the radiation layer 30 but not contacting with the radiation layer 30, the central conductor 51 further insulated from the ground layer 40. The grounding coat 52 electrically connects with the grounding layer 40 for fixing the coaxial cable 5 and grounding layer 40 together. The circular polarization antenna 100 further includes a feed-in portion 311 vertically extending from the radiation layer 30 and towards the ground layer 40. The feed-in portion 311 is configured for keeping apart from the central of the radiation layer 30.

The ground layer 40 and the radiation layer 30 are preferably manufactured from a sheet metal. Furthermore, the radiation layer 30 of the circular polarization antenna 100 is a circular metal patch having a pair of notches 312 thereon. The notches 312 are symmetrically positioned on the edge of the radiation layer 30. The feed-in portion 311 is configured as a nail vertically extending from the radiation layer 30. Thus, the feed-in portion 311 is paralell to the central conductor 51 of the coaxial cable 5. Both the length of the feed-in portion 311 and the central conductor 51 are approximately changed around one fourth wavelength corresponding to the frequency of 60 GHz. So, the feed-in portion 311 could be able to resonate with the central conductor 51 for transmitting or receiving radio frequency signals.

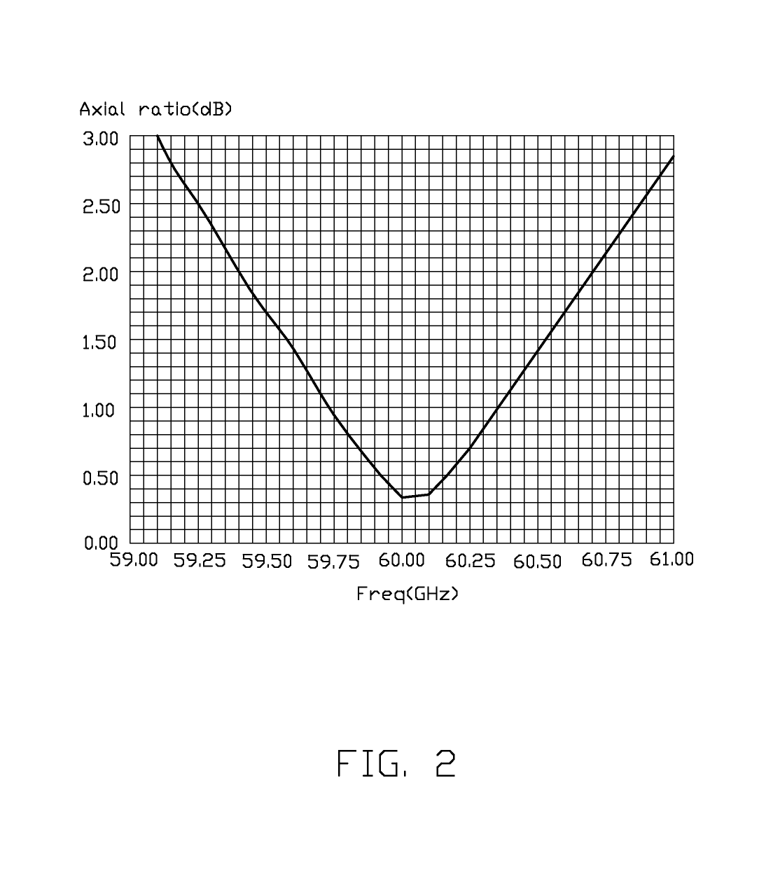

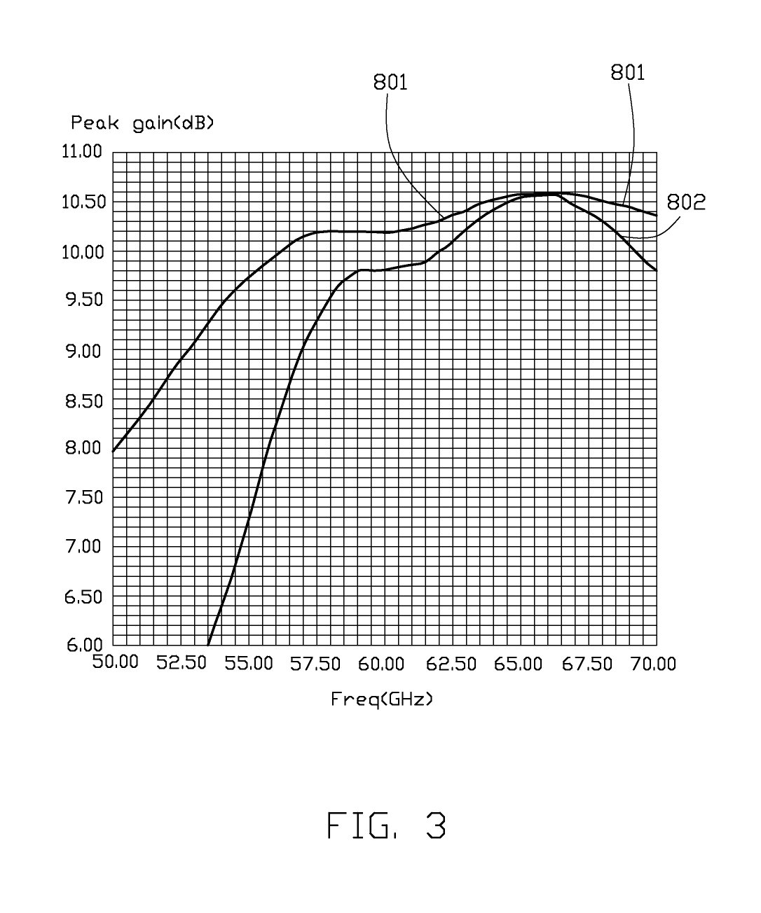

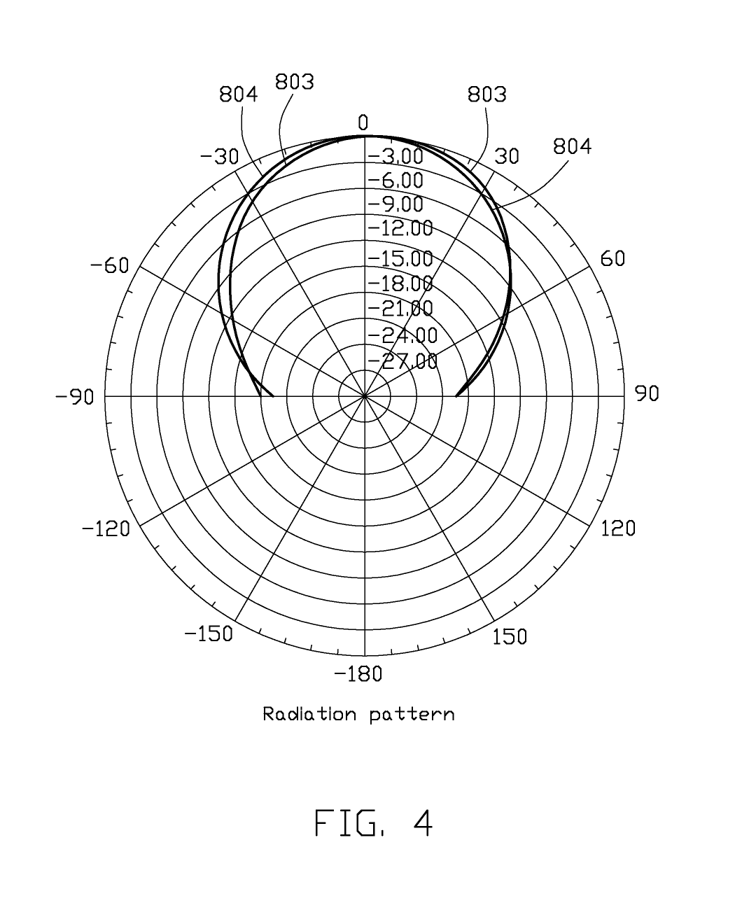

Referring to FIG. 2, the axial ratio graph shown us the circular polarization antenna 100 has a range of a 1.30 GHz bandwidth approximate between 59.40 GHz to 60.70 GHz, which under a axial ratio of 2 dB. The peak linear gain shown by FIG. 3 includes a first line 801 and a second line 802. The first line 801 is a theoretical standard linear gain for this circular polarization antenna 100; and the second line 802 is an effectively level of this circular polarization antenna 100. The second line 802 shown us the circular polarization antenna 100 has a wider bandwidth which having a peak gain above 10 dB. Simulated radiation patterns (horizontal and vertical cuts) on both polarizations at a frequency of 60 GHz are shown in FIG. 4. The line 803 indicates a radiation pattern along a horizontal direction. The line 804 indicates a radiation pattern along a vertical direction.

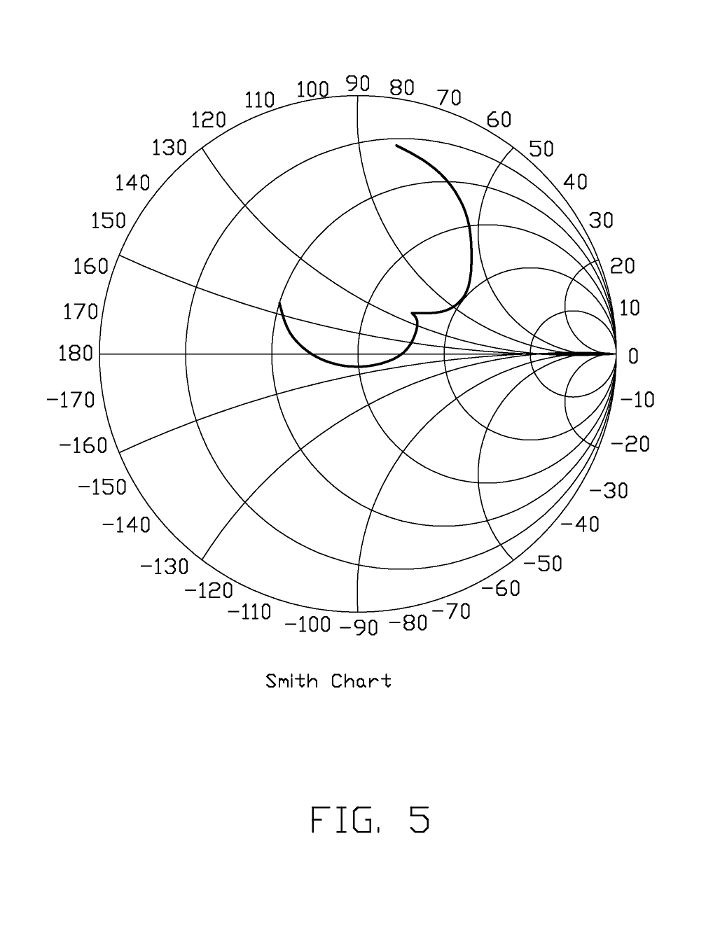

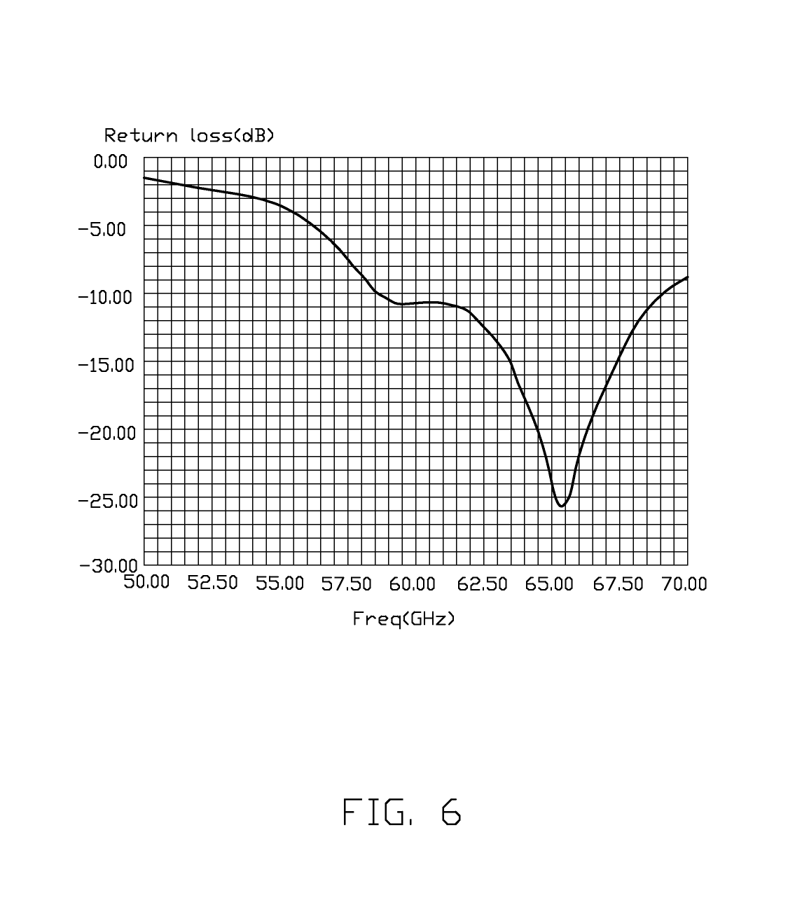

FIG. 5 shows a Smith Chart around a frequency of 60 GHz of the circular polarization antenna 100. FIG. 6 shows a test chart recording of return loss of the circular polarization antenna 100 at different frequencies between 50 GHz and 70 GHz. The return loss is lower than −10 dB from 58.5 GHz and 69 GHz.

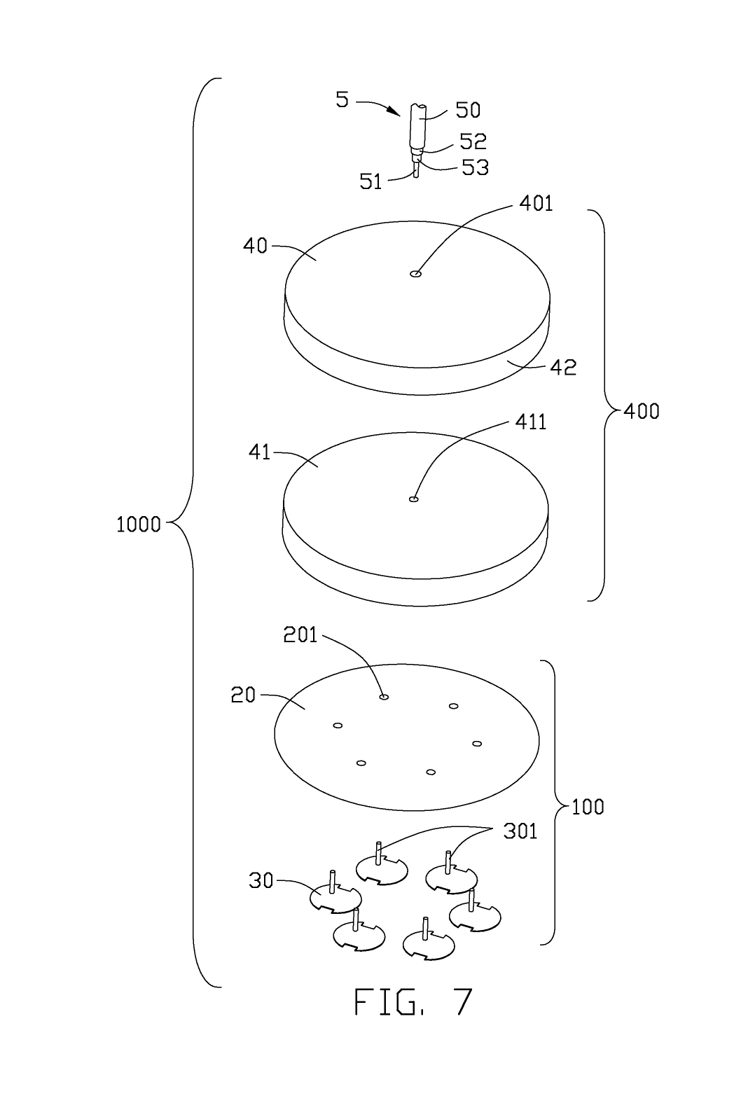

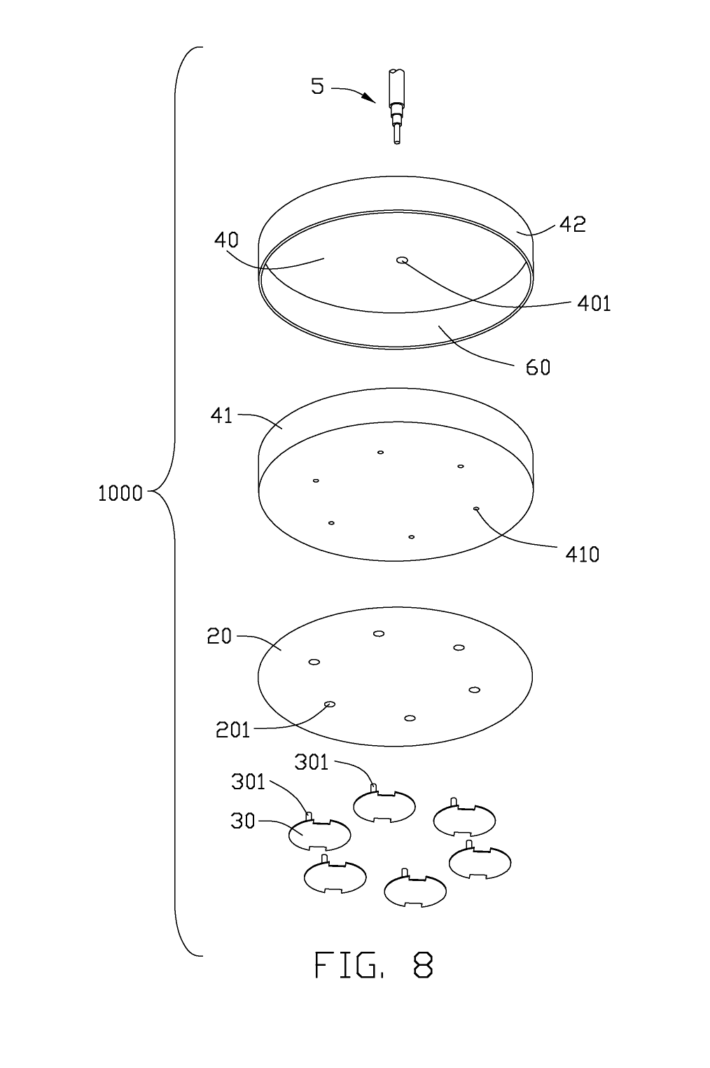

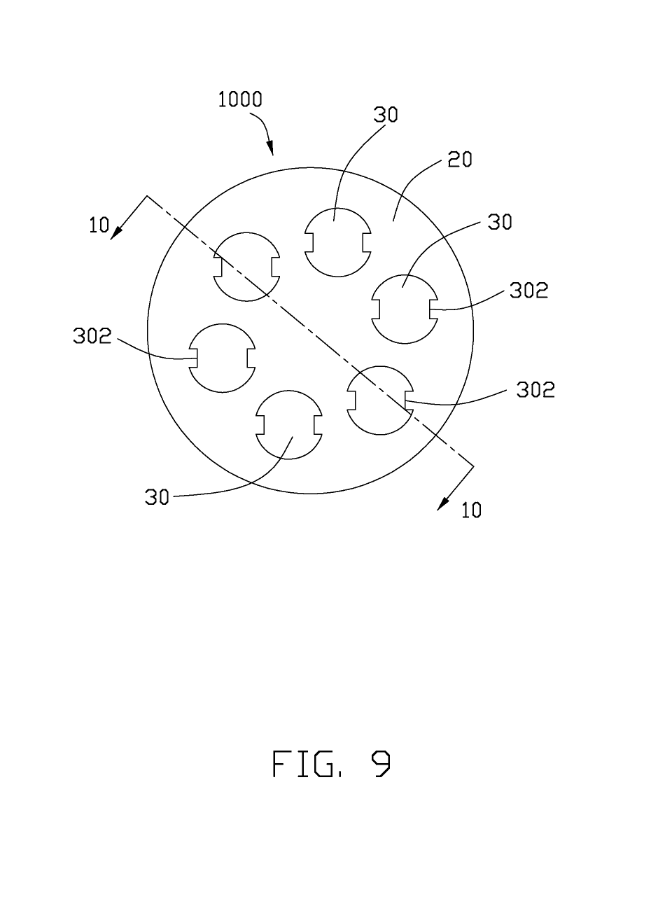

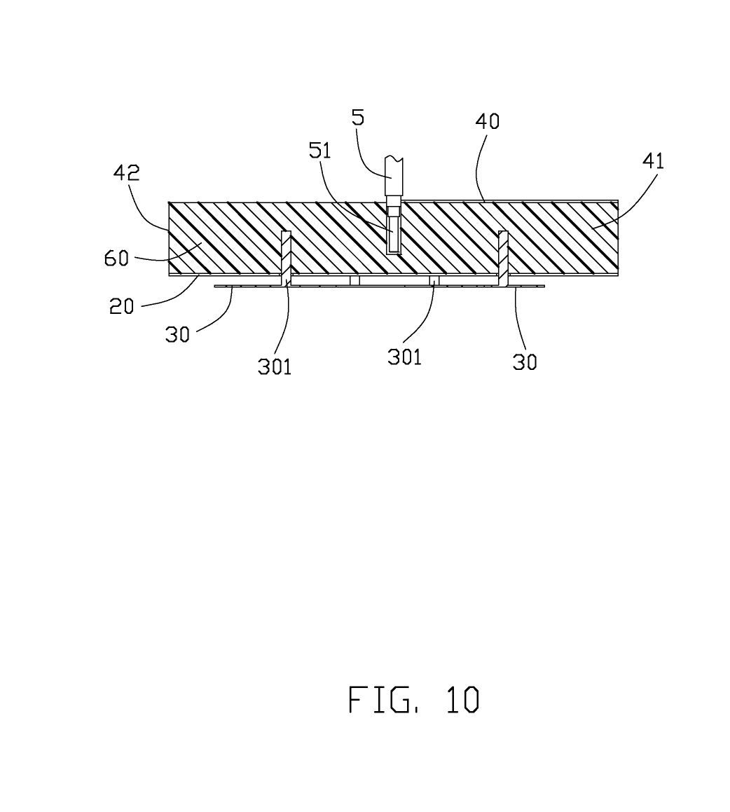

In conjunction with FIGS. 7 to 10, a directional antenna array 1000 made in accordance with the first embodiment of the present invention comprises a plurality of circular polarization antennas 100 which having a common ground layer 40. The directional antenna array 1000 includes six units, in this embodiment patches 30 which are coplanar with each other to form a radiation layer, a reflection layer 20, a waveguide 41, and a ground layer 40.

The ground layer 40 and the reflection layer 20 are connected together by a side wall 42 extending from the edge of the ground layer 40, so as to form a substantially closed radiation space 60 therein. The waveguide 41 is filled within the radiation space 60.

A nail 301 extending vertically from a bottom surface of each patch 30. Each pair of the patch 30 and nail 301 is shaped as a thumbtack has a pair of notches 302 symmetrically defined on the edge. However, the nail 301 is positioned apart from the central of the patch 30. The reflection layer 20 is preferably manufactured from a sheet metal having a circle edge approximate same as the ground layer 40. There are six locating holes 201 configured for receiving the nail 301 separately. Especially, all of the nails 301 are insulated from the reflection layer 20. These nails 301 extending into the radiation space 60 are fixed into the waveguide 41, and the waveguide 41 preferably made from an insulative material. In another embodiment, the waveguide 41 could be changed into the air when these patches 30 are fixed from other ways, like sticking on a panel from the top surface of coplanar patches 30.

The directional antenna array 1000 further includes a coaxial cable 5 which assembled to the ground layer 40 as shown in the circular polarization antenna 100. The central conductor 51 is parallel to these nails 301 for resonating with each other. The waveguide 41 has a lower hole 111 defined on the bottom side. The lower hole 111 is configured for receiving the central conductor 51 of the coaxial cable 5. The waveguide 41 further has six upper holes 410 positioned on a top side for receiving the nails 301. Obviously, each of the upper holes 410 is aligned to the locating holes 201 separately. The upper holes 410 are positioned on a circle (not shown) which centred around the lower hole 111, it means that the nails 301 are on a circle around the central conductor 51. In order to get a perfect radiation performance, it's preferable to let these nails 301 dividing the circle into six equal parts.

When the directional antenna array 1000 receiving radio frequency signals, the radio signals should be transmitted from the patches 30 to their nails 301, and then the nails 301 transmitting the radio signals to the coaxial cable 5 by resonating with the central conductor 51 in the shielded radiation space 60.

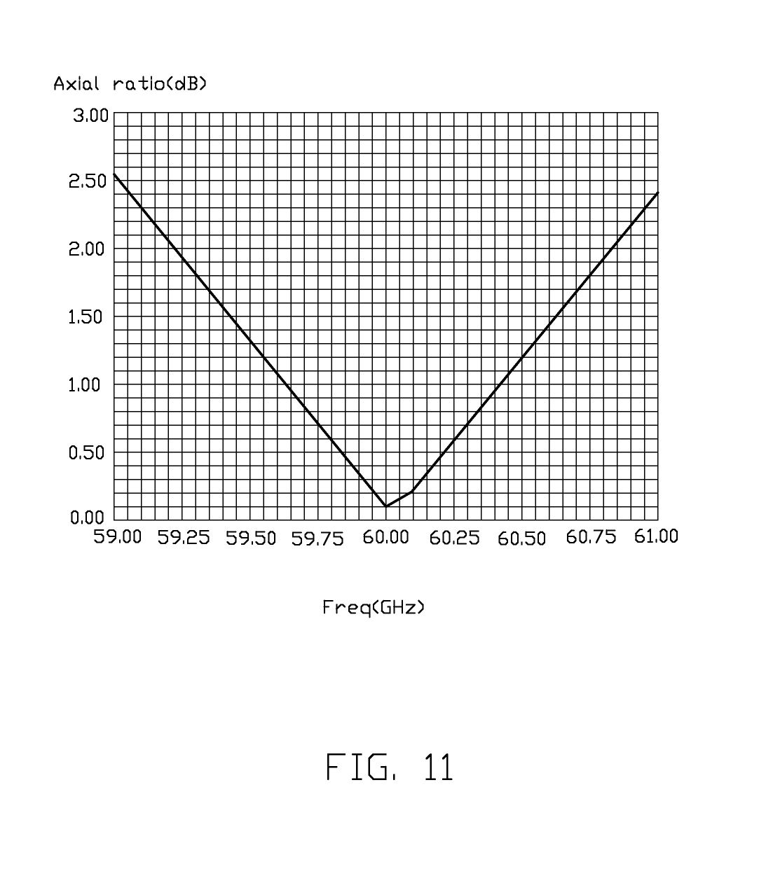

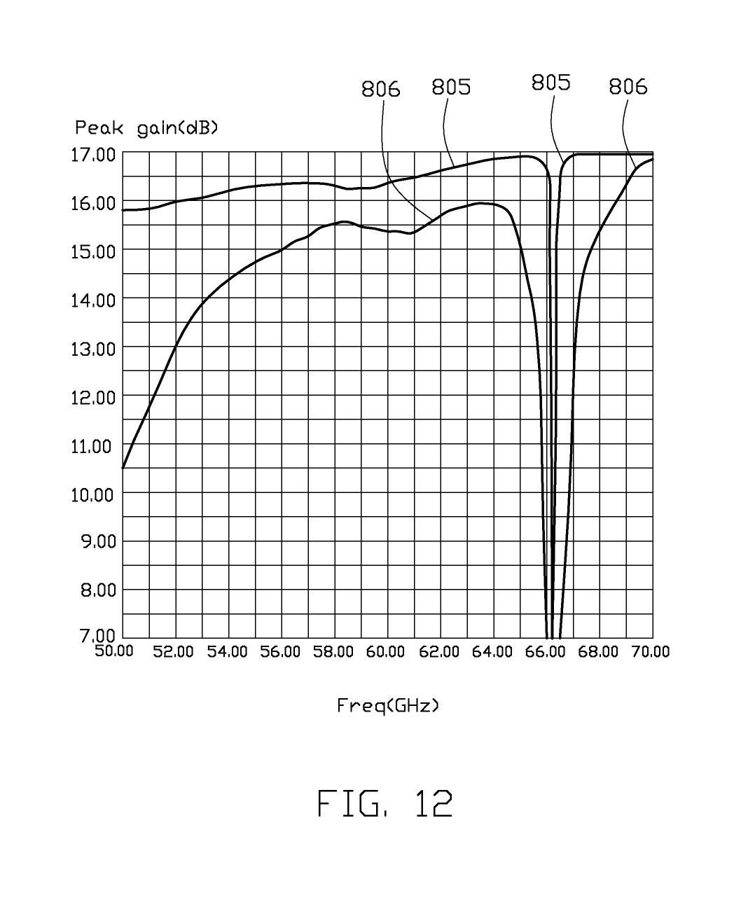

Referring to FIG. 11, the axial ratio graph shown us the directional antenna array 1000 has a range of a 1.60 GHz bandwidth approximate between 59.20 GHz to 60.80 GHz, which under a axial ratio of 2 dB. The peak linear gain shown by FIG. 12 includes line 805 and line 806. The line 805 is a theoretical standard linear gain for this directional antenna array 1000; and the line 806 is an effectively level of the directional antenna array 1000 considered the loss of reflection. The line 806 shown us the directional antenna array 1000 has a wider bandwidth which having a peak gain above 10 dB.

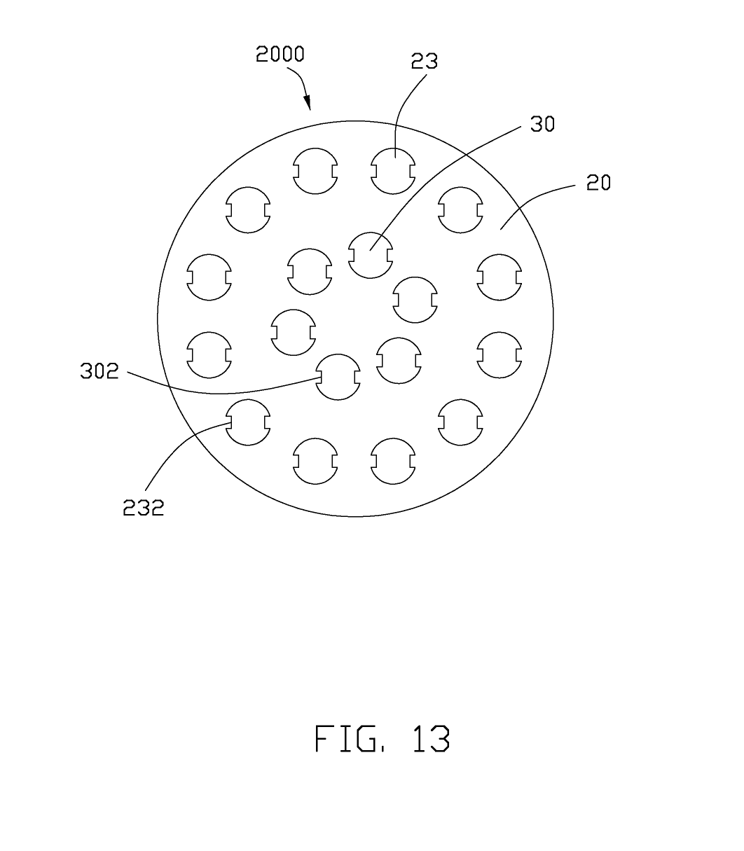

In conjunction with FIG. 13, a directional antenna array 2000 is made in accordance with the second embodiment of the present invention. The directional antenna array 2000 also has reflection layer 20 defined a plurality of locating holes 201 thereon, a ground layer 40 (not shown), and a coaxial cable 5 (not shown). The directional antenna array 2000 further has a plurality of patches 30, 23 positioned along two circles which having a same center. According to the first embodiment of the directional antenna array 1000, the center of these two circles is the central conductor 51 (not shown). Each of the patches 30 which positioned on the inner circle has a pair of notches 302 opening to a first direction. Each of the patches 23 which positioned on the outer circle has a pair of notches 232 opening to a second direction. The first direction is parallel to the second direction in the second embodiment of the present invention.

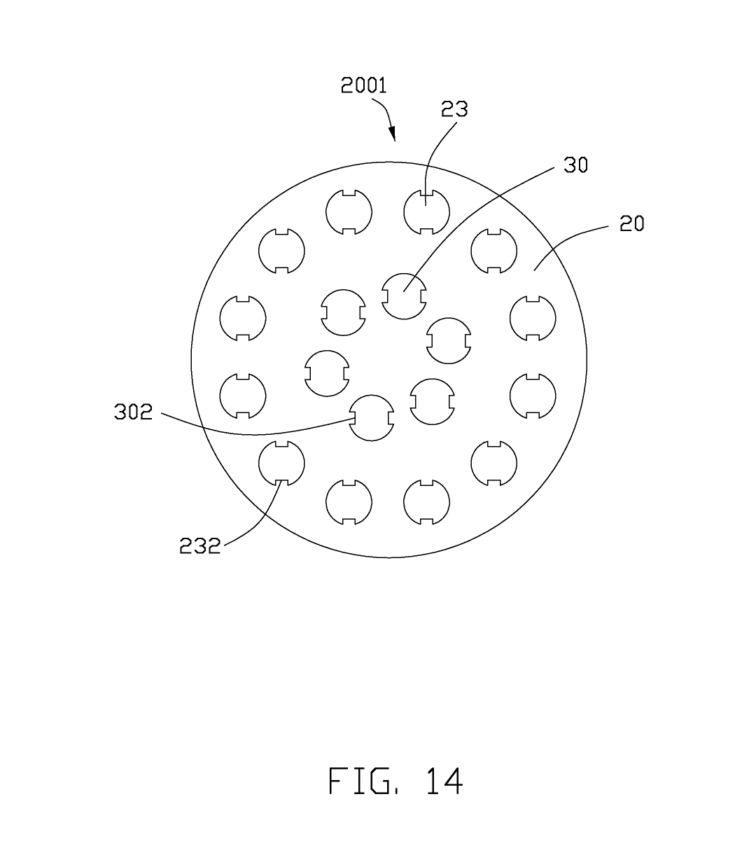

In conjunction with FIG. 14, a directional antenna array 2001 made in accordance with the third embodiment of the present invention is shown to us.

The first direction is configured to be perpendicular to the second direction in the third embodiment of the present invention according to the directional antenna array 2000.

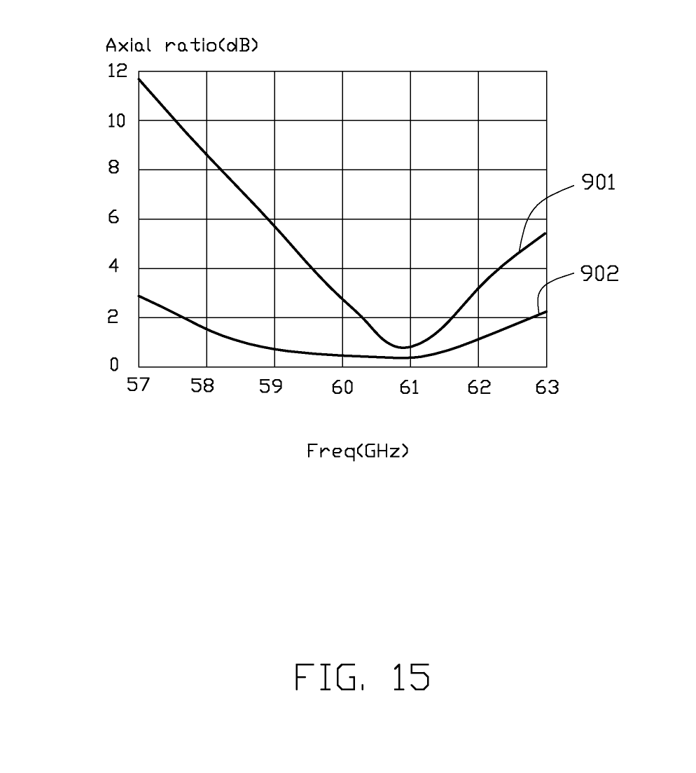

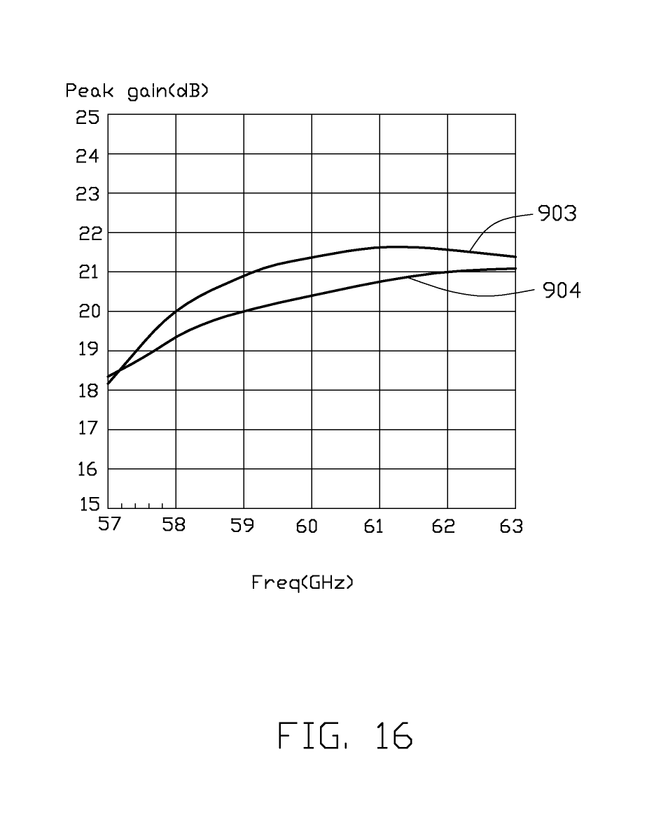

Referring to FIG. 15, the axial ratio graph indicates for both of the directional antenna array 2000 and the directional antenna array 2001. The line 901 indicates the directional antenna 2000, and the line 902 indicates the directional antenna 2001. From the FIG. 15, we can see the directional antenna array 2001 which has vertically opening notches 302 is better than the directional antenna array 2000. Almost a range of a 5.0 GHz bandwidth approximate between 57.00 GHz to 63.00 GHz, which under an axial ratio of 2 dB. The peak linear gain shown by FIG. 16 includes line 903 and line 904. The line 903 is indicates the directional antenna 2000, and the line 904 indicates the directional antenna 2001.

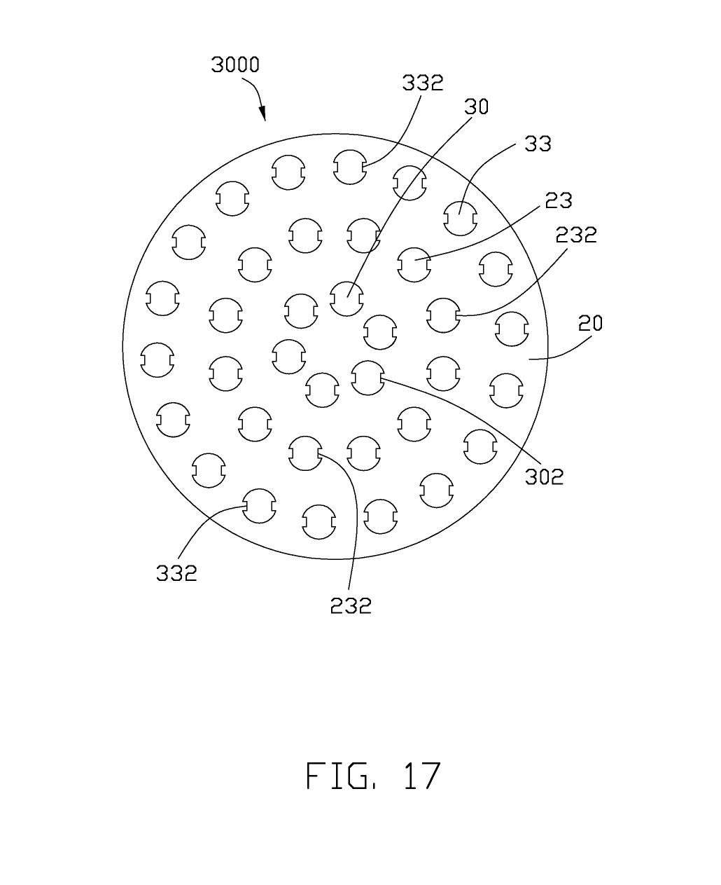

In conjunction with FIG. 17, a directional antenna array 3000 is made in accordance with the fourth embodiment of the present invention. The directional antenna array 3000 has a plurality of patches 30, 23, 33 respectively positioned on three circles which having a same center. According to the first embodiment and the second embodiment, the center of these three circles is the central conductor 51 (not shown). Each of the patches 30 which positioned on the inner circle has a pair of notches 302 symmetrically opening to a first direction. Each of the patches 23 which positioned on the middle circle has a pair of notches 232 symmetrically opening to a second direction. Each of the patches 33 which positioned on the outer circle has a pair of notches 332 symmetrically opening to a third direction. Both the first direction and the second direction are parallel to the third direction in the fourth embodiment of the present invention.

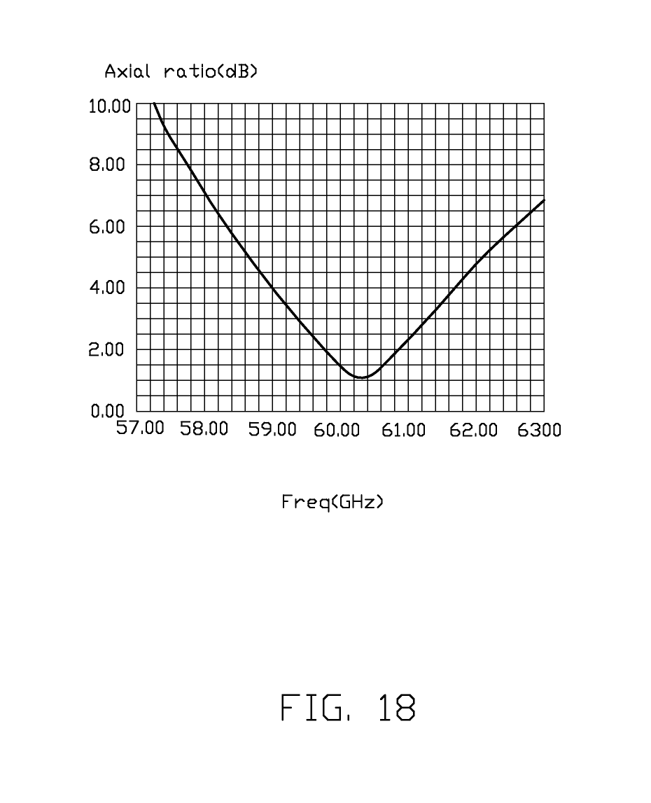

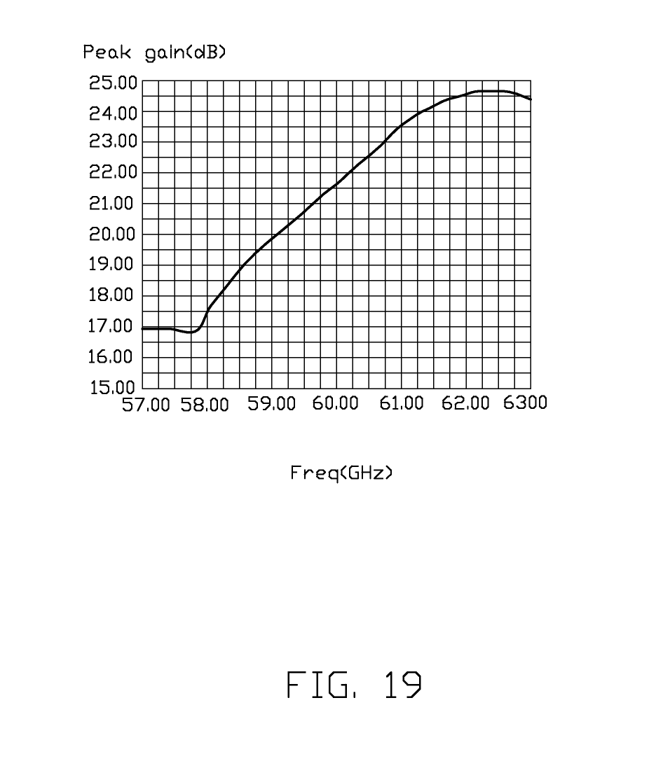

FIG. 18 is an axial ratio graph illustrating the directional antenna array 3000 between 57.00 GHz to 63.00 GHz. The bandwidth approximately reaches 1 GHz which having an axial ratio under 2 dB between 60 GHz and 61 GHz. The peak linear gain shown by FIG. 19 indicates the directional antenna 3000 having a peak gain above 16.5 dB between the frequency 57 GHz and 63 GHz.

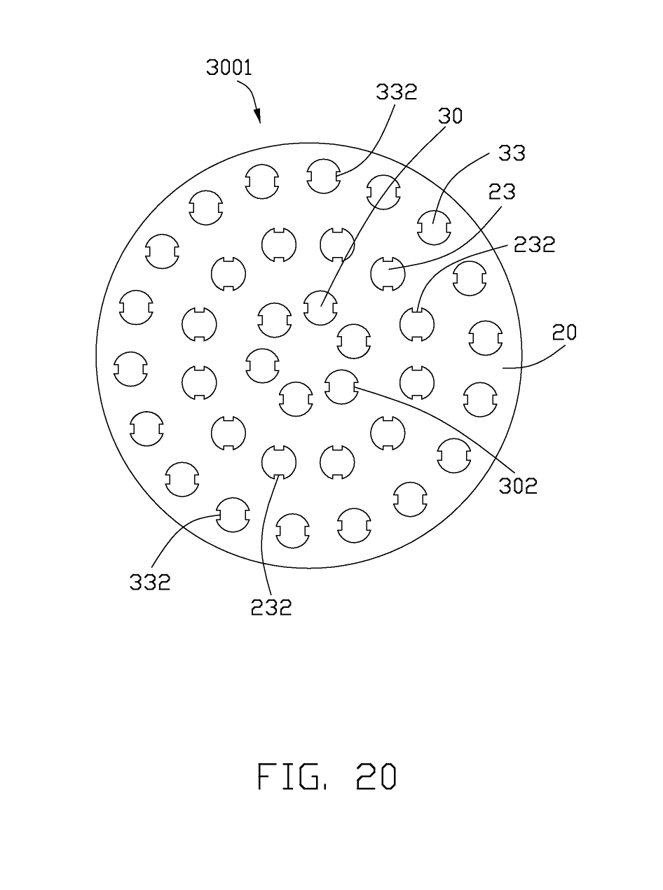

In conjunction with FIG. 20, a directional antenna array 3001 made in accordance with the fifth embodiment of the present invention is shown to us. In this embodiment, each of the patches 30 which positioned on the inner circle has a pair of notches 302 opening to a horizontal direction. Each of the patches 23 which positioned on the middle circle has a pair of notches 232 symmetrically opening to a vertical direction. Each of the patches 33 which positioned on the outer circle has a pair of notches 332 symmetrically opening to a horizontal direction. It means that the second direction vertical to the first direction and third direction in the fifth embodiment of the present invention.

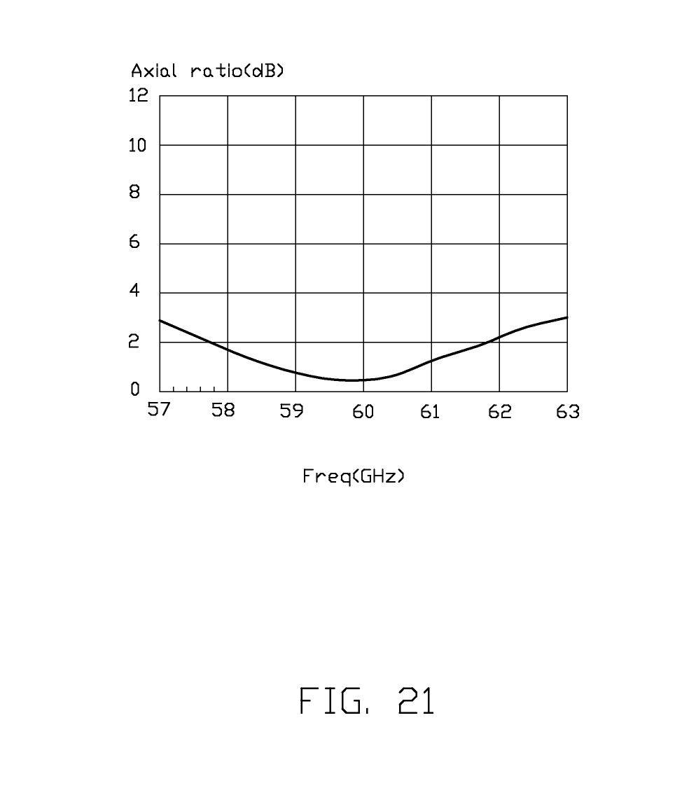

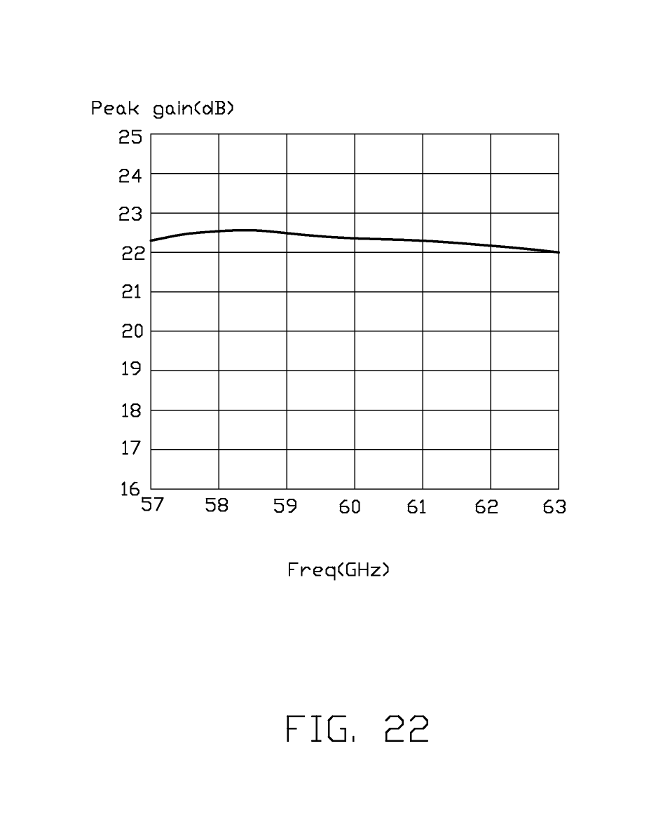

FIG. 21 is an axial ratio graph illustrating the directional antenna array 3001 between 57.00 GHz to 63.00 GHz. The bandwidth approximately reaches 4 GHz which having an axial ratio under 2 dB between 57.8 GHz and 61.8 GHz. The peak linear gain shown by FIG. 22 indicates the directional antenna 3001 having a peak gain above 22 dB between the frequency 57 GHz and 63 GHz.

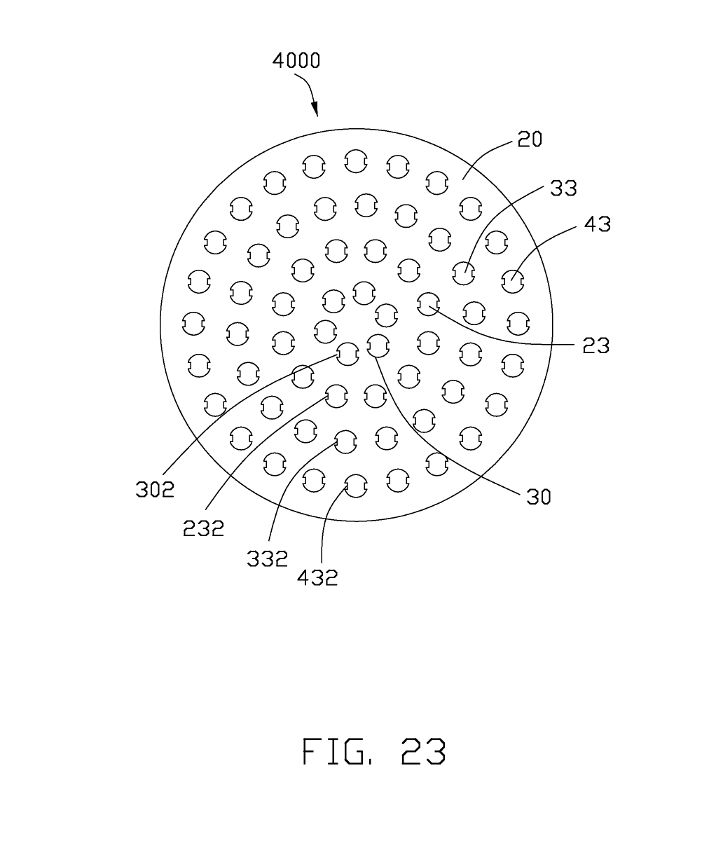

In conjunction with FIG. 23, a directional antenna array 4000 is made in accordance with the sixth embodiment of the present invention. The directional antenna array 4000 has a plurality of patches 30, 23, 33, 43 respectively positioned on four circles which having a same center. According to the above embodiments, the center of these four circles is the central conductor 51 of the coaxial cable 5 (not shown). Each of the patches 30, 23, 33, 43 respectively has a pair of notches 302, 232, 332, 432 symmetrically defined on their edge. All of these notches 302, 232, 332, 432 are defined opening to a horizontal direction.

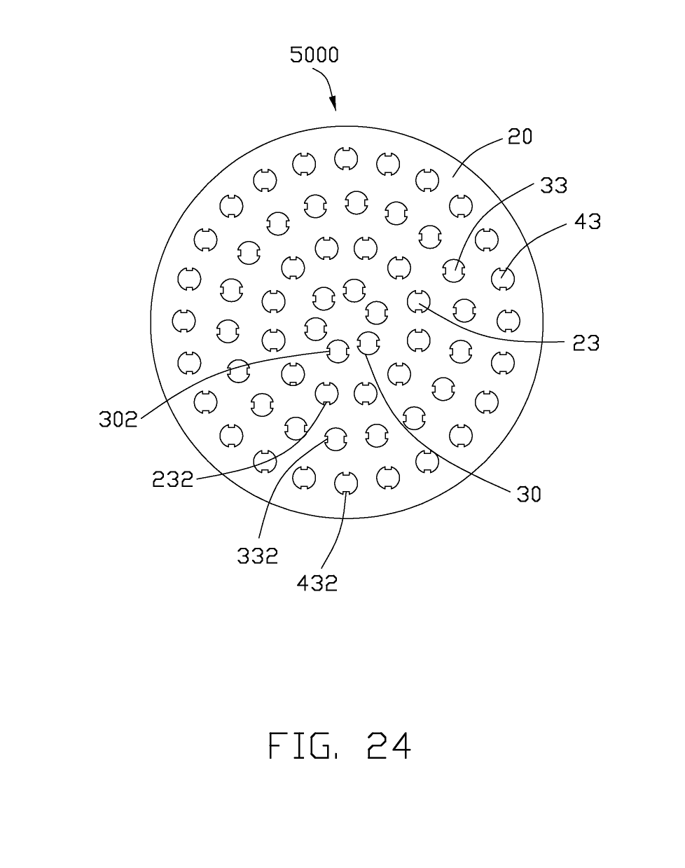

In conjunction with FIG. 24, a directional antenna array 5000 is made in accordance with the seventh embodiment of the present invention. The directional antenna array 5000 has a plurality of patches 30, 23, 33, 43 respectively positioned on four circles same as the directional antenna array 4000. The center of these four circles is the central conductor 51 of the coaxial cable 5 (not shown). Each of the patches 30, 23, 33, 43 respectively has a pair of notches 302, 232, 332, 432 symmetrically defined on their edge. The notches 302, 332 are defined opening to a horizontal direction, and the notches 232, 432 are defined opening to a vertical direction.

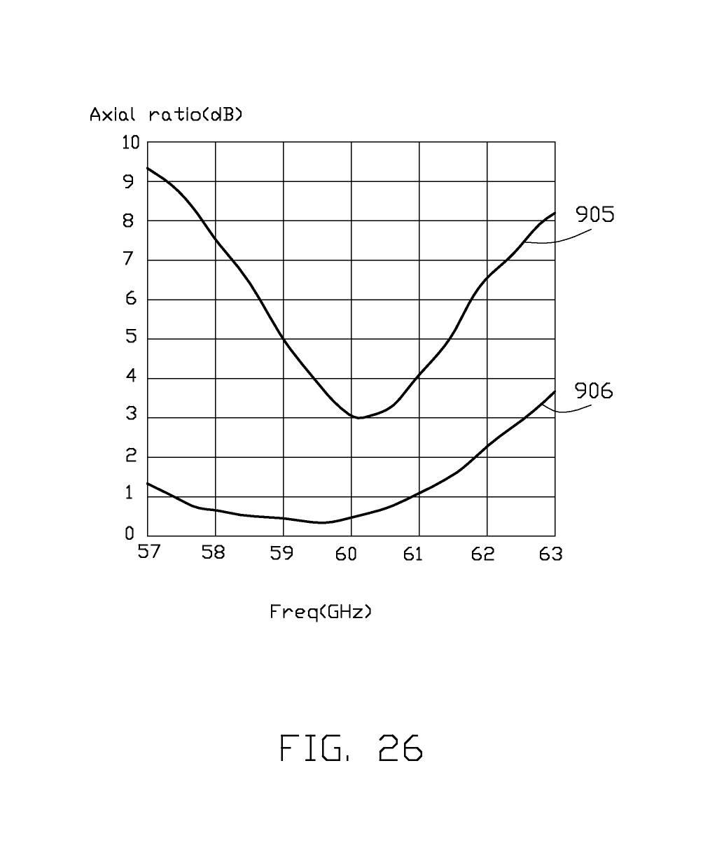

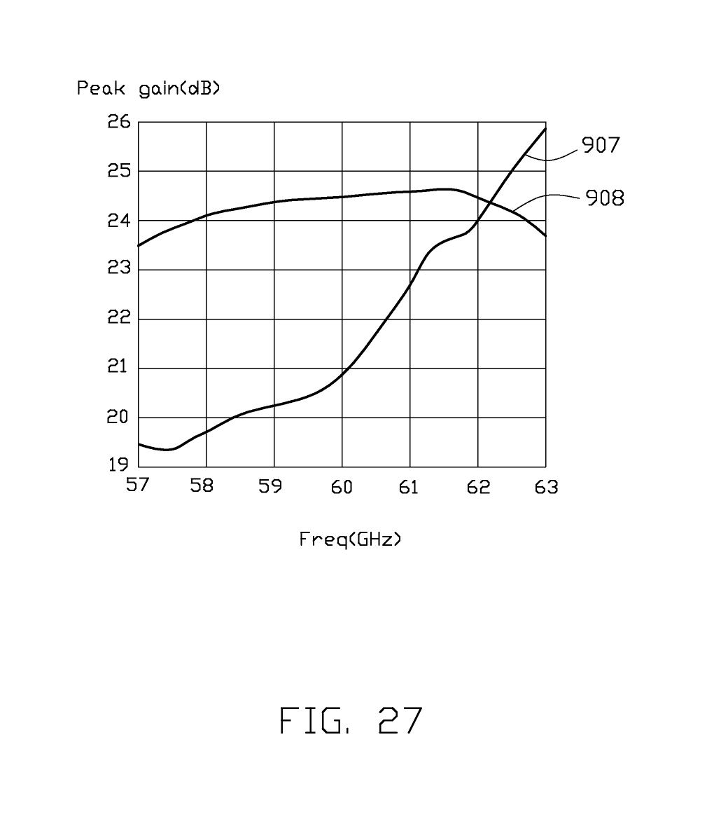

Referring to FIG. 26, the axial ratio graph indicates for the directional antenna array 4000 and the directional antenna array 5000. The line 905 indicates the directional antenna 4000, and the line 906 indicates the directional antenna 5000. From the FIG. 26, we can see the directional antenna array 5000 is better than the directional antenna array 4000. Nearly a range of a 5.0 GHz bandwidth approximate between 57.00 GHz to 62.00 GHz, which under an axial ratio of 2 dB. The peak linear gain shown by FIG. 27 includes line 907 indicating antanna array 4000, and line 908 indicating antenna array 5000. From the FIG. 27, we can see both of the two antenna array 4000, 5000 having a good performance in gain pattern. Further more, the directional antenna array 5000 has a perfect peak gain data (above 23 dB between frequency 57 GHz and 63 GHz), which better than the peak gain data of the directional antenna array 4000.

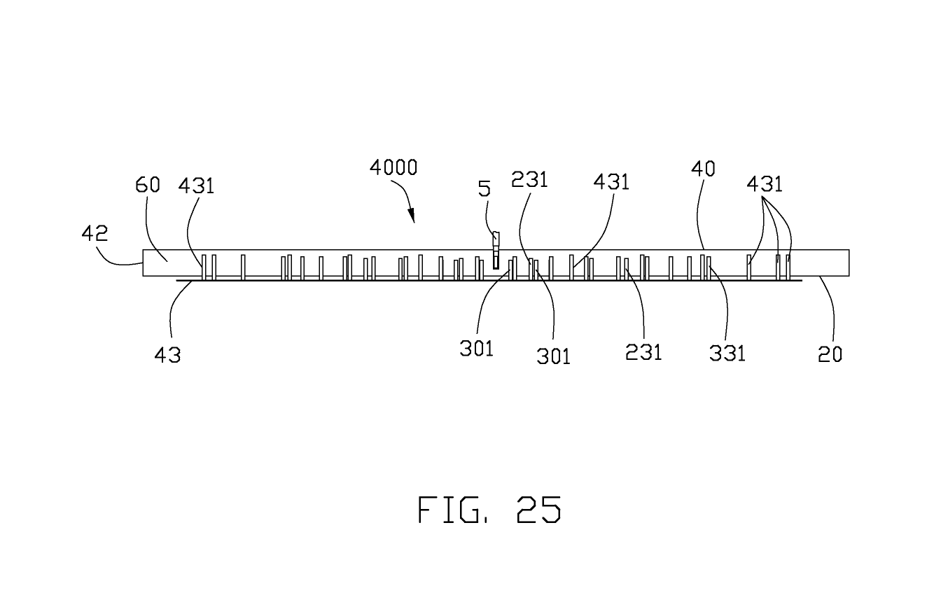

Referring to FIG. 25, the directional antenna array 5000 includes a plurality of circular polarization antennas which having a common ground layer 40, a common reflection layer 20. Each of the patches 30, 23, 33, 43 respectively has a nail 301, 231, 331, 431 extending through the reflection layer 20, and resonating with the central conductor 51 of the coaxial cable 5. The farther the nail away from the central conductor, the longer length of the nail has. In all of the above embodiments, the nails which positioned on a circle divide the circle into equal parts, and the number of these parts is an integer multiple of 6.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna array comprising:
a horizontal ground layer having a central hole;
a radiation layer spaced from the ground layer; and
a coaxial cable including a central conductor, an outer insulated layer, and a grounding coat outside the insulated layer, the central conductor upwardly extending through the central hole from a bottom side of the ground layer and insulated from the ground layer, said grounding coat electrically contacting with said ground layer; wherein
the radiation layer includes a plurality of radiation units coplanar with one another and each parallel to the ground layer, the antenna array further including a plurality of nails each extending downwardly from the radiation unit to the ground layer, said nails resonated with the central conductor.

2. The antenna array as claimed in claim 1, further including a reflection layer positioned between the radiation layer and the ground layer, said reflection layer having a plurality of locating holes, and wherein the nail extends through a corresponding hole without contacting the reflection layer.

3. The antenna array as claimed in claim 2, wherein each of the reflection layer and the ground layer is configured as a sheet metal having a circular edge and connected together by a sidewall, and wherein the ground layer, the sidewall, and the reflection layer form a cage defining a substantially closed radiation space therein.

4. The antenna array as claimed in claim 3, wherein the radiation space is filled with an insulator, the insulator having a lower hole configured for receiving said central conductor and a plurality of upper holes configured for receiving said nails, respectively.

5. The antenna array as claimed in claim 1, wherein the radiation unit comprises a patch shaped as a circular metal sheet having a pair of notches symmetrically defined on an edge thereof.

6. The antenna array as claimed in claim 5, wherein the nail is vertically extending from the patch at a position away from the center of the patch.

7. The antenna array as claimed in claim 1, wherein the nails of the radiation units are positioned along a plurality of circles centered around the central conductor.

8. The antenna array as claimed in claim 7, wherein the nails on a same circle are configured to divide the circle into a plurality of equal parts.

9. The antenna array as claimed in claim 7, wherein the nails on a same circle have same length.

10. The antenna array as claimed in claim 9, wherein the length of the nail in an outer circle is longer than the length of the nail in an inner circle.

11. A circular polarization antenna comprising:
a horizontal ground layer having a central hole;
a radiation layer parallel to the ground layer; and
a coaxial cable including a central conductor, an insulated layer coated on the central conductor, and a grounding coat coated on the insulated layer, the central conductor upwardly extending through the central hole from the bottom side of the ground layer and insulated from the ground layer, said grounding coat electrically contacting with said ground layer; wherein
a feed-in portion vertically extending towards the ground layer, said feed-in portion coupled with said central conductor.

12. The circular polarization antenna as claimed in claim 11, further including a reflection layer positioned between the radiation layer and the ground layer, said reflection layer having a locating hole, said locating hole separately receiving the feed-in portion.

13. The circular polarization antenna as claimed in claim 11, wherein each of the reflection layer and the ground layer is configured as a metal sheet having a circular edge and connected together by a sidewall so that the ground layer, the sidewall, and the reflection layer together define a cage having a substantially closed radiation space therein.

14. The circular polarization antenna as claimed in claim 11, wherein the radiation layer has a patch shaped as a circular metal sheet having a pair of notches, said notches symmetrically defined on the edge of the patch.

15. The circular polarization antenna as claimed in claim 11, wherein the feed-in portion is distanced from a center of the radiation layer.

16. An antenna comprising:
a horizontal grounding layer defining a through hole;
a radiation layer distanced from the grounding layer with a space therebetween;
a coaxial feeder cable including an inner conductor extending through the through hole and into the space without touching the grounding layer, and an outer conductor isolated from the inner conductor by an insulator and linked to the grounding layer; and
the radiation layer including a plurality of radiation units having a similar size and shape and symmetrically surrounding the inner conductor; wherein
each of said radiation units defines a patch parallel to the grounding layer, and a nail extending from the patch toward the grounding layer and into the space to resonate with the inner conductor.

17. The antenna as claimed in claim 16, wherein said radiation units form two ring structures surrounding the inner conductor.

18. The antenna as claimed in claim 16, wherein each of said radiation units defines a long side and a short side to be directional

19. The antenna as claimed in claim 18, wherein the space is surrounded by the grounding layer and a reflection layer, which is vertically opposite to said grounding layer and between the grounding layer and the patches of the radiation units, and a circumferential side wall connected between the grounding layer and the reflection layer.

20. The antenna as claimed in claim 16, wherein in each radiation unit, the nail is located offset from a center of the corresponding patch.
